(19) United States
(12) Patent Application Publication
(10) Pub. No.: US 2023/0179358 A1
(43) Pub. Date: Jun. 8, 2023

(54) METHOD, DEVICE AND COMPUTER READABLE MEDIUM FOR COMMUNICATION

(71) Applicant: NEC CORPORATION, Tokyo (JP)

(72) Inventors: Yukai GAO, Beijing (CN); Gang WANG, Beijing (CN)

(73) Assignee: NEC CORPORATION, Tokyo (JP)

(21) Appl. No.: 17/998,110

(22) PCT Filed: May 8, 2020
(86) PCT No.: PCT/CN2020/089273

§ 371 Date: Nov. 7, 2022

(51) Int. Cl. H04L 5/00

(52) U.S. Cl. CPC H04L 5/0048

(57) ABSTRACT

Embodiments of the present disclosure relate to methods, devices and computer readable media for communication of a RS. A method of communication comprises determining, at a network device, first information about a first resource for communication of a reference signal and second information about a modification of the first resource; and transmitting the first and second information to a terminal device for determination of a second resource for performance of the communication of the reference signal. The method further comprises receiving, at the terminal device, the first and second information; determining a second resource based on the first and second information; and performing the communication of the reference signal based on the second resource. Embodiments of the present disclosure can achieve a dynamic configuration for a RS resource, and enhance flexibility of the RS resource configuration. In addition, the related overhead can be saved.

### TECHNICAL FIELD

Embodiments of the present disclosure generally relate to the field of telecommunication, and in particular, to methods, devices and computer storage media for communication of a reference signal (RS).

### BACKGROUND

In recent study on a new radio (NR) technology, it is agreed that enhancements on aperiodic RS triggering are critical to facilitate more flexible triggering and downlink control information (DCI) overhead or usage reduction. In this event, it has been proposed to allow dynamic RS triggering slot offset indication. However, no detailed solution on the dynamic indication is proposed, especially considering both triggering flexibility and DCI overhead.

### SUMMARY

In general, embodiments of the present disclosure provide methods, devices and computer storage media for communication of a RS.

In a first aspect, there is provided a method of communication. The method comprises: receiving, at a terminal device and from a network device, first information about a first resource for communication of a reference signal and second information about a modification of the first resource; determining a second resource based on the first and second information; and performing the communication of the reference signal based on the second resource.

In a second aspect, there is provided a method of communication. The method comprises: determining, at a network device, first information about a first resource for communication of a reference signal and second information about a modification of the first resource; and transmitting the first and second information to a terminal device for determination of a second resource for performance of the communication of the reference signal.

In a third aspect, there is provided a terminal device. The terminal device comprises a processor and a memory coupled to the processor. The memory stores instructions that when executed by the processor, cause the terminal device to perform the method according to the first aspect of the present disclosure.

In a fourth aspect, there is provided a network device. The network device comprises a processor and a memory coupled to the processor. The memory stores instructions that when executed by the processor, cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating a possible failure of communication of a RS in a current RS triggering scheme;

FIG. 3 illustrates a schematic diagram illustrating a process for communication of a RS according to embodiments of the present disclosure;

FIG. 4 illustrates an example method of communication implemented at a terminal device in accordance with some embodiments of the present disclosure;

FIG. 5 illustrates a schematic time-frequency diagram illustrating an offset adjustment in a resource modification according to some embodiments of the present disclosure;

FIG. 6 illustrates a schematic time-frequency diagram illustrating an effective time of a resource modification according to some embodiments of the present disclosure;

FIG. 7 illustrates an example method of communication implemented at a network device in accordance with some embodiments of the present disclosure; and

FIG. 8 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Internet of Everything (IoE) devices, machine type communication (MTC) devices, device on vehicle for V2X communication where X means pedestrian, vehicle, or infrastructure/network, or image capture devices such as digital cameras, gaming devices, music storage and playback appliances, or Internet appliances enabling wireless or wired Internet access and browsing and the like. The term “terminal device” can be used interchangeably with a UE, a mobile station, a subscriber station, a mobile terminal, a user terminal or a wireless device. In addition, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a next generation NodeB (gNB), a Transmission Reception Point (TRP), a Remote Radio Unit (RRU), a radio head (RH), a remote radio head (RRH), a low power node such as a femto node, a pico node, and the like.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device and the second network device. In one embodiment, a first information may be transmitted to the terminal device from the first network device and a second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In current RS design in NR, a slot offset for aperiodic RS triggering is semi-statically configured by a higher layer parameter. For codebook, non-codebook or antenna-switching based transmissions, only one aperiodic RS resource set for each of these transmissions is supported, and thus only one slot offset is allowed for each of these transmissions. However, due to variation of a slot format configuration, especially for dynamic slot changing by DCI format 2_0, the slot offset configured for the aperiodic RS resource may be unavailable in some cases.

In view of the above, embodiments of the present disclosure provide an improved solution of dynamic configuring a RS resource. According to embodiments of the present disclosure, information about a modification for a configured RS resource is transmitted from a network device to a terminal device, so that the configured RS resource can be updated or adjusted for ensuring a transmission of a RS. In this way, dynamic configuration for a RS resource can be achieved, and flexibility of the RS resource configuration can be enhanced. Principles and implementations of the present disclosure will be described in detail below with reference to the figures.

According to embodiments of the present disclosure, a network device and a terminal device may communicate with each other based on time slots (or slots for short) as defined in the 3GPP specifications. For example, for subcarrier spacing configuration µ, slots are numbered 1 } in an increasing order within a subframe and in an increasing order within a frame. There are consecutive Orthogonal Frequency Division Multiplexing (OFDM) symbols in a slot where depends on the cyclic prefix as given in related 3GPP specifications (TS 38.211), as shown in Table 1 and Table 2 below. The start of slot in a subframe is aligned in time with the start of OFDM symbol in the same subframe. Other related definitions and information of slots can be found in existing or future 3GPP specifications. More generally, the term slot as used herein can refer to any existing defined unit of time or any unit of time to be defined in the future.

TABLE 1

Number of OFDM symbols per slot, slots per frame, and slots per subframe for normal cyclic prefix.

| µ | ${N}_{\text{symb}}^{\text{slot}}$ | ${N}_{\text{slot}}^{\text{frame,} μ}$ | ${N}_{\text{slot}}^{\text{subframe,} μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 2

Number of OFDM symbols per slot, slots per frame, and slots per subframe for extended cyclic prefix.

| µ | ${N}_{\text{symb}}^{\text{slot}}$ | ${N}_{\text{slot}}^{\text{frame,} μ}$ | ${N}_{\text{slot}}^{\text{subframe,} μ}$ |
|---|---|---|---|
| 2 | 12 | 40 | 4 |

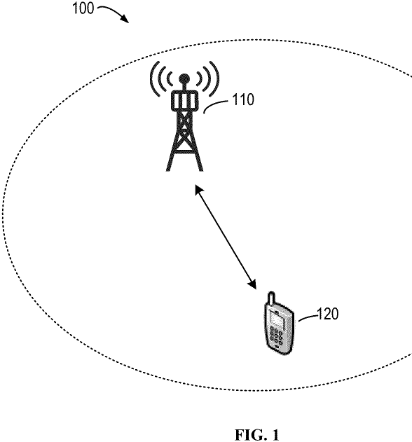

FIG. 1 illustrates a schematic diagram of an example communication network 100 in which embodiments of the present disclosure can be implemented. As shown in FIG. 1, the communication network 100 may include a network device 110 and a terminal device 120 served by the network device 110. It is to be understood that the number of devices in FIG. 1 is given for the purpose of illustration without suggesting any limitations to the present disclosure. The communication network 100 may include any suitable number of network devices and/or terminal devices adapted for implementing implementations of the present disclosure.

As shown in FIG. 1, the network device 110 and the terminal device 120 may communicate with each other via downlink and uplink channels such as wireless communication downlink and uplink channels. For example, communication of a RS may be performed between the network device 110 and the terminal device 120. In some embodiments, the network device 110 may transmit a downlink RS to the terminal device 120 for at least one of channel evaluation/estimation, channel characteristic estimation and compensation, phase noise estimation, time and/or frequency tracking and associated demodulation of downlink transmission, and the terminal device 120 may correspondingly receive the downlink RS. For example, the downlink RS may be any one or more of a demodulation reference signal (DMRS), a cell reference signal (CRS), a multicast broadcast single frequency network (MBSFN) reference signal, a positioning reference signal (PRS), a fine time/frequency tracking reference signal (TRS), a phase tracking reference signal (PTRS) and a channel state information-reference signal (CSI-RS). It should be note that the reference signal may be any downlink RS existing in the art or to be developed in the future.

In some alternative embodiments, the terminal device 120 may transmit a RS (i.e., an uplink RS) to the network device 110 for at least one of channel evaluation/estimation, channel characteristic estimation and compensation, phase noise estimation, time and/or frequency tracking, channel estimation for downlink channel, and associated modulation of uplink transmission, and the network device 110 may correspondingly receive the uplink RS. For example, the RS may be any one or more of a sounding reference signal (SRS), a demodulation reference signal (DMRS), a positioning reference signal (PRS), a fine time/frequency tracking reference signal (TRS) and a phase tracking reference signal (PTRS). It should be note that the reference signal may be any uplink RS existing in the art or to be developed in the future.

The communications in the communication network 100 may conform to any suitable standards including, but not limited to, Global System for Mobile Communications (GSM), Long Term Evolution (LTE), LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

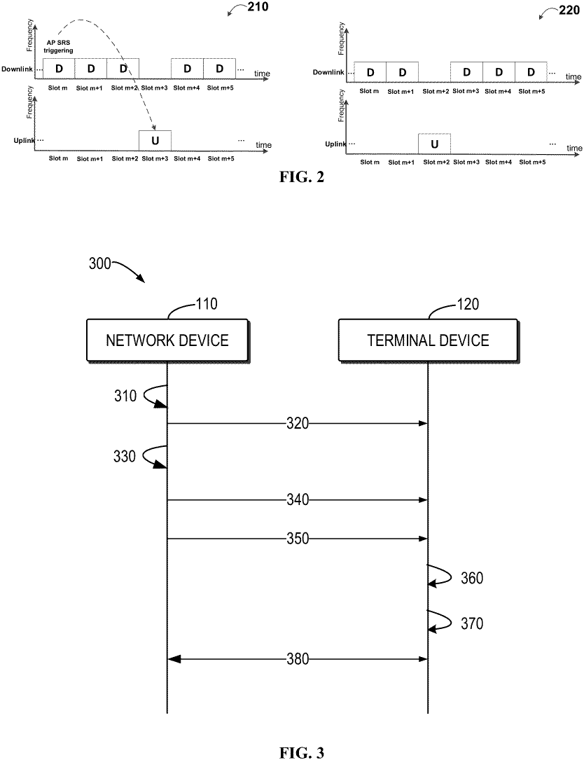

As mentioned above, in current RS design in NR, for codebook, non-codebook or antenna-switching based transmissions, only one aperiodic RS resource set for each of these transmissions is supported, and thus only one slot offset is allowed for each of these transmissions. However, due to variation of a slot format configuration, especially for dynamic slot changing by DCI format 2_0, the slot offset configured for the aperiodic RS resource may be unavailable in some cases. FIG. 2 illustrates a schematic diagram illustrating a possible failure of communication of a RS in a current RS triggering scheme. In this example, SRS is taken as an example of a RS for illustration.

Reference sign 210 shows the case of suitable offset for the aperiodic SRS resource, and reference sign 220 shows the case of unsuitable offset for the aperiodic SRS resource. As shown by reference sign 210, slots m, m+1, m+2, m+4 and m+5 are configured for downlink transmission (denoted as D in FIG. 2) and slots m+3 is configured for uplink transmission (denoted as U in FIG. 2) according to current slot format configuration. Assuming that an offset value of 3 is configured for SRS transmission. When information triggering SRS transmission is received by the terminal device 120 in slot m, a terminal device may transmit SRS in slot n+3 via an uplink transmission. However, when the slot format configuration is varied, for example, as shown by reference sign 220, slots m, m+1, m+3, m+4 and m+5 are configured for downlink transmission and slots m+2 is configured for uplink transmission, there is no slot suitable for triggering SRS transmission with slot offset 3. In addition, as shown in reference sign 210, only slot m is suitable for aperiodic SRS triggering, as the configured slot offset is 3 in this example, which may restrict the flexibility.

In addition, in current RS design in NR, the slot offset may be ranged from 0 to 32. For the most flexible case, all available slot offset values are indicated by DCI. In this case, 6 bits will be needed for transmission of the DCI, and thus a large DCI overhead will be caused.

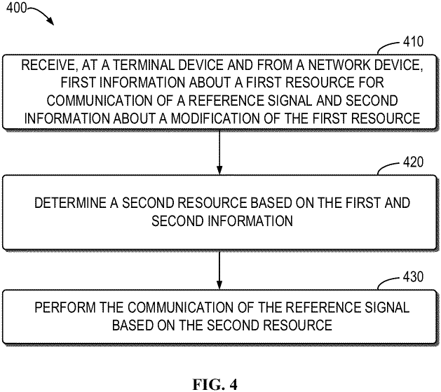

In view of the above, embodiments of the present disclosure provide an improved solution of dynamic or flexible configuring a RS resource. According to embodiments of the present disclosure, information about a modification for a configured RS resource is transmitted from the network device 110 to the terminal device 120, so that the configured RS resource can be updated or adjusted for a transmission of a RS. It will be described with reference to FIG. 3.

FIG. 3 shows a schematic diagram illustrating a process 300 for communication of a RS according to embodiments of the present disclosure. For the purpose of discussion, the process 200 will be described with reference to FIG. 1. The process 300 may involve the network device 110 and the terminal device 120 as illustrated in FIG. 1.

As shown in FIG. 3, the network device 110 may determine 310 first information about a first resource configured for communication of a RS. As discussed above, the RS may be any downlink or uplink reference signal existing in the art or to be developed in the future. For the purpose of discussion, the following description will be made by taking a SRS as an example of the RS.

In some embodiments, the first information may comprise a first slot offset value of the first resource. In some alternative embodiments, the first information may comprise a set of slot offset values for the first resource. In some embodiments where multiple resource sets are configured for the first resource, the first information may comprise a set of slot offset values (also referred to as a first set of slot offset values below) for the multiple resource sets. For example, the values of slot offset in the set are different to each other. In some embodiments, the first set of slot offset values may comprise a slot offset value for each of the multiple resource sets. In some embodiments, the number of slot offset values in the first set of slot offset values may be smaller than the number of the multiple resource sets.

The network device 110 transmits 320 the first information to the terminal device 120. In some embodiments, the network device 110 may configure the first information to the terminal device 120 in a radio resource control (RRC) message. It should be note that the first information may be transmitted in any other suitable ways, for example, in a media access control (MAC) control element (CE) or a downlink control information (DCI), and the present disclosure does not make limitation for this.

Depending on actual needs, such as a variation of a slot format configuration, the network device 110 may determine 330 second information about a modification of the first resource. In some embodiments, the second information may comprise a second slot offset value for replacement of the first slot offset value. In some embodiments where multiple resource sets are configured for the first resource and the first information comprises a first set of slot offset values for the multiple resource sets, the second information may comprise a second set of slot offset values in replacement of the first set of slot offset values. In this way, the first resource can be updated, and flexibility of RS resource configuration can be enhanced.

In some alternative embodiments, the second information may comprise an offset value with respect to the first resource. In some embodiments where multiple resource sets are configured for the first resource and the first information comprises a first set of slot offset values for the multiple resource sets, the second information may comprise a set of offset values with respect to the first set of slot offset values. In this way, the first resource can be adjusted, and flexibility of RS resource configuration can be enhanced. In addition, the overhead for the adjustment can be reduced compared with that for the replacement.

Upon determining the second information, the network device 110 may transmit 340 the second information to the terminal device 120. In some embodiments, the network device 110 may transmit the second information in DCI. In some embodiments, the network device 110 may transmit the second information in a media access control (MAC) control element (CE). It should be note that the second information may be transmitted in any other suitable ways, and the present disclosure does not make limitation for this.

Based on the first and second information, the terminal device 120 may determine a second resource for communication of the RS. In some embodiments where the network device 110 transmits 350 third information triggering the communication of the RS and the terminal device 120 correspondingly receives the third information, the terminal device 120 may determine 360 a slot of the reception of the third information, and determine 370 the second resource based on the first and second information and the slot. For example, the terminal device 120 may determine a final slot offset value based on the first and second information, and determine the second resource as a slot no earlier than the slot of the reception of the third information by the final slot offset value. More details about the determination of the final slot offset value will be described later with reference to Embodiment 1 and Embodiment 2.

Then the terminal device 120 may perform 380 the communication of the RS based on the determined second resource. In some embodiments where the RS is a downlink RS, the terminal device 120 may receive the RS on the second resource. In some embodiments where the RS is an uplink RS, the terminal device 120 may transmit the RS on the second resource.

According to the process in FIG. 3, dynamic configuration for a RS resource can be achieved, and flexibility of the RS resource configuration can be enhanced. In addition, the related overhead can be saved. Corresponding to the process described in FIG. 3, embodiments of the present disclosure provide methods of communication implemented at a terminal device and at a network device. These methods will be described below with reference to FIGS. 4-7.

FIG. 4 illustrates an example method 400 of communication implemented at a terminal device in accordance with some embodiments of the present disclosure. For example, the method 400 may be performed at the terminal device 120 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the terminal device 120 receives first information about a first resource for communication of a RS and second information about a modification of the first resource. In some embodiments, the terminal device 120 may receive the first information in a RRC message from the network device 110, and receive the second information in at least one of a MAC CE and DCI from the network device 110. It should be noted that, any other suitable ways are also feasible for the reception of the first and second information.

In some embodiments, the second information may be received at the same timing as the reception of the first information. In some embodiments, the second information may be received at a timing later than the reception of the first information. In some embodiments, the second information may be received together with third information triggering the communication of the RS. In some embodiments, the second information may be received in DCI format 2_0 when a slot format configuration is varied.

In some embodiments, the RS may be a downlink RS. For example, the RS may be any one or more of a DMRS, a CRS, a MBSFN RS, a PRS, a TRS, a PTRS and a CSI-RS. In some alternative embodiments, the RS may be an uplink RS. For example, the RS may be any one or more of a SRS, a DMRS, a PRS, a TRS and a PTRS. It should be noted that the RS may be any downlink or uplink reference signal existing in the art or to be developed in the future.

The following description is made on the modification of the first resource with reference to Embodiment 1 and Embodiment 2.

### Embodiment 1

In this embodiment, the first information may comprise a first slot offset value (for example, denoted as O1), and the second information may comprise a second slot offset value (for example, denoted as O2) different from the first slot offset value. The first and second slot offset values are set with respect to a slot for triggering communication of a RS.

In some embodiments, the first and second slot offset values may be non-negative integers. For example, the first slot offset value O1∈ {0,1,2 ... Omax}, and the second slot offset value 02∈ {0,1,2 ... Omax}. In some embodiments, maximum offset Omax may be predetermined. In some alternative embodiments, Omax may be configured or preconfigured. In some embodiments, Omax is a positive integer. For example, 1≤ Omax ≤ 512. For example, Omax may be one of 32, 64, 128, 256 and 512. It should be noted that any other suitable values are also feasible.

In some embodiments, the second slot offset value is above the first slot offset value. In these embodiments, the terminal device 120 may replace the first slot offset value with the second slot offset value and determine the second slot offset value as a final slot offset value for RS resource determination.

In some embodiments, the terminal device 120 may select one of the first and second slot offset values as a final slot offset value. In some embodiments, the terminal device 120 may determine whether a resource determined based on the second slot offset value is available. In some embodiments, the resource determined based on the second slot offset value may be a slot. In some embodiments, the resource or the slot determined based on the second slot offset value is regarded as available if there are available uplink symbol(s) for the configured time-domain location(s) in the resource or in the slot for all the RS resources in the resource set and/or if the resource or the slot satisfies the minimum timing requirement between the triggering information and all the RS resources in the resource set. For example, the terminal device 120 may make the determination depending on its capability. If the resource is available, the terminal device 120 may determine the second slot offset value as the final slot offset value. If the resource is unavailable, the terminal device 120 may determine the first slot offset value as the final slot offset value. In some embodiments, if the resource determined based on the first slot offset value is available, the terminal device 120 may determine the first slot offset value as the final slot offset value. In some embodiments, if the resource determined based on the first slot offset value is available, and if the resource determined based on the second slot offset value is available, the terminal device 120 may determine the first slot offset value as the final slot offset value. In some embodiments, if the resource determined based on the first slot offset value is unavailable, and if the resource determined based on the second slot offset value is available, the terminal device 120 may determine the second slot offset value as the final slot offset value. In some embodiments, if the resource determined based on the first slot offset value is unavailable, and if the resource determined based on the second slot offset value is unavailable, the terminal device 120 may not transmit or receive the RS.

In some alternative embodiments, the first information may comprise a set of first slot offset values, and the second information may comprises at least one of the following: a subset in the set, and a slot offset value from the set. For example, the set may be denoted as S1, and each element S1′ of S1 is a non-negative integer, and S1′∈ {0,1,2 ... Omax}. In some embodiments, Omax may be predetermined. In some embodiments, Omax may be configured. In some embodiments, Omax is a positive integer. For example, 1 ≤Omax ≤, 512. For example, Omax may be any one of 32, 64, 128, 256 and 512. It should be noted that any other suitable values are also feasible. In some embodiment, the second information may comprise a subset M1, each element M1′ of M1 is a non-negative integer and M1′ ∈S1. In some alternative or additional embodiments, the second information may comprise a value from M1.

In some embodiments, the set S1 may be configured in a RRC message and/or a MAC CE to the terminal device 120, and the number of S1 is N1, N1 is a non-negative integer and

$$0 ⩽ \text{N} 1 ⩽ \text{Omax} + 1.$$

And one value from the set S1 may be indicated in a DCI. For example, the bit field for DCI may be ceil(log₂(N1)) or ceil(log₂(Omax+1)).

For example, in some embodiments, the set S1 may be configured in a RRC message to the terminal device 120, and the subset M1 may be activated in a MAC CE and one value from the subset M1 may be indicated in a DCI.

In some alternative embodiments, the set S1 may be configured in a RRC message to the terminal device 120, and the number of S1 is N1, N1 is a non-negative integer and 0 ≤N1 ≤Omax+1.

In some embodiments a subset of slot offset (e.g. M1, where each value M1′ of M1 is non-negative integer, and M1′ ∈S1) may be activated in a MAC CE. The number of values in M1 is N2, N2 is a non-negative integer, and 0≤N2≤N1. One value from the set M1 may be indicated in DCI. For example, the bit field for DCI may be ceil(log₂(N1)) or ceil(log₂(N2)).

In some embodiments, there may be a number X, and X is a positive integer, and 1 ≤X≤32. For example, X = 2 or 4 or 8 or 16 or 32. In some embodiments, the number X may be predetermined or configured in RRC and/or MAC CE and/or DCI.

In some embodiments where N1 is larger than or equal to X (i.e., N1 ≥X), a subset of slot offset (e.g. M1, where each value M1′ of M1 is non-negative integer, and M1′ ∈ S1) may be activated in a MAC CE. The number of values in M1 is N2, N2 is a non-negative integer, and 0≤N2≤X. One value from the set M1 may be indicated in DCI. For example, the bit field for DCI may be ceil(log₂(X)) or ceil(log₂(N2)). In some embodiments where N1 is smaller than X (i.e., N1 < X), one value from the set S1 may be indicated in DCI, without a MAC CE for activation a subset. For example, the bit field for DCI may be ceil(log₂(X)) or ceil(log₂(N1)).

In some embodiments where multiple resource sets are configured for the first resource, the first information may comprise a first set of slot offset values for the multiple resource sets, and the second information may comprise a second set of slot offset values. In this case, the terminal device 120 may determine multiple resource sets of the second resource based on the second set of slot offset values in replacement of the first set of slot offset values. For example, the number of the multiple resource sets is denoted as N, N is positive integer and 1<N≤ 16. For example, the number of slot offset values in the first set of slot offset values is denoted as M, M is positive integer and 1<M≤16. For example, the M slot offset values are different to each other. For example, M≤N.

In some embodiments, the second set of slot offset values may comprise a set of slot offset values for at least part of the multiple (N) resource sets. Here, the part of the multiple resource set is denoted as P resource sets, 0≤P≤N. For example, X bits may be set for the field of slot offset update for a single RS resource set, X is positive integer, and 1≤X≤6. In some embodiments, the second set of slot offset values may comprise a slot offset value for each of N resource sets. For example, X bits may be set for the field of slot offset update for a single RS resource set, X is positive integer, and 1 ≤X≤6. For example, total X*N or X*P bits may be needed. In some embodiments, there may be a field to indicate the index of the RS resource set. For example, Y bits or Y = ceil(log2(N)) for the field for RS resource set index, Y is positive integer, and 1≤Y≤4. For example, for each of the P RS resource sets, the total number of bits may be X+Y. For example, total (X+Y)*N bits or (X+Y)*P bits may be needed.

### Embodiment 2

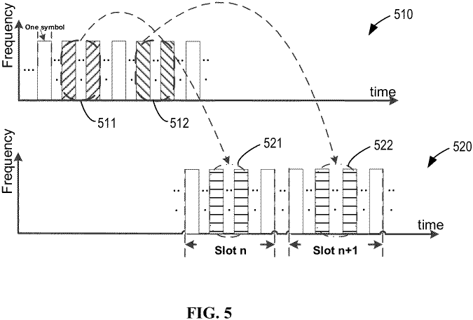

In this embodiment, the first information may comprise a first slot offset value (for example, denoted as O1), and the second information may comprise an offset value (for example, denoted as F1) with respect to the first slot offset value. This will be described in detail with reference to FIG. 5.

FIG. 5 illustrates a schematic time-frequency diagram illustrating an offset adjustment in a resource modification according to some embodiments of the present disclosure. Reference sign 510 shows the case of a downlink, and reference sign 520 shows the case of an uplink. Reference sign 511 shows a downlink control channel such as a PDCCH triggering an AP RS. According to the configured offset in RRC (for example, O1), the AP RS will be communicated in uplink slot n as denoted by 521. Reference sign 512 shows a downlink control channel such as a PDCCH transmitting the second information. In this example, the second information comprises F1=1. Upon offset adjustment, the AP RS will be communicated in uplink slot n+1 as denoted by 522.

In some embodiments, the offset value F1 may be an integer. For example, -5≤ F1≤5, or -2≤F1≤3 or 0≤F1≤10 or -10≤F1≤10. It should be noted that any other suitable values are also feasible.

In some embodiments, the terminal device 120 may determine a final slot offset value based on the first slot offset value O1 and the offset value F1. For example, the final slot offset value may be determined as min (max (A, O1+F1), B) or min(O1+F1,B) or max(A, O1+F1). For example, A is a first value, and A is a non-negative integer, 0≤A≤Omax or 0≤A≤10. For example, B is a second value , and B is a positive integer, A≤B≤512 or 1 ≤B≤Omax, or 10≤B≤512. In some embodiments, the first and second values may be predetermined. In some embodiments, the first and second values may be configured or preconfigured. For example, A=0. For example, B=32 or 64. It should be noted that any other suitable values are also feasible for A and B.

In some embodiments, the offset value F1 may be selected from a set of offset values. In some embodiments, an offset value in the set may be associated with at least one of the first slot offset value O1 and a slot format configuration. For example, the number of F1 in the set is Z, Z is a non-negative integer. For example, 0≤Z≤16. The number of F1 (i.e. Z) and/or the available values in F1 (e.g. Fₖ, where 0<=k<=Z-1) depends on at least one of the value of O1 and slot format configuration.

In some embodiments, for a subset of O1 and/or a subset of slot format configurations, the number of F1 is Zi, and for another subset of O1 and/or another subset of slot format configurations, the number of F1 is Zj, and Zi≠Zj . In some embodiments, for a subset of O1 and/or a subset of slot format configurations, the possible values of F1 is Fₘ, and for another subset of O1 and/or another subset of slot format configurations, the value of possible values of F1 is Fₙ, and there is at least one value in Fₘ, which is different from any one value in Fₙ. In some embodiments, -O1 ≤F1≤Omax-O1. For example, when O1 = 0, there is no negative value of F1. For example, when O1=Omax, there is no positive value of F1. In some embodiments, 0≤F1≤Omax or 0 ≤F1≤ Omax-O1 or 1≤ F1 ≤Omax or 1 ≤F1 ≤Omax-O1.

In some embodiments, if the configured offset value in RRC is O1, and if the AP RS is triggered in slot n, the number of F1 and/or the possible values in F1 may be determined based on the uplink slots (or slots which can transmit AP RS or available slots) between slot n+O1-A and slot n+O1+B or between slot n+A and slot n+B or between slot n+O1 and slot n+B or between slot n+O1 and slot n+O1+B or between n+A and slot n+O1+B or between slot n and slot n+B or between slot n and slot n+O1+B. For example, A is a non-negative integer. For example, B is a positive integer. In some embodiments, the value of A and/or B may be predetermined or configured via at least one of RRC, MAC-CE and DCI. For example, 0≤A≤5 or0≤A≤10 or 0≤A≤Omax. For example,1≤B≤6 or 1≤B≤10 or 1≤B≤Omax. As another example, 0≤A≤O1. As another example, 1≤B≤Omax-O1. It should be noted that any other suitable values are also feasible for A and B.

In some embodiments, the maximum number or number of F1 may be predetermined or configured via at least one of RRC, MAC-CE and DCI. For example, the maximum number or the number may be H, H is an integer and 0≤ H≤32. In some embodiments, if the configured offset value in RRC is O1, and if the AP RS is triggered in slot n, the possible/available values in F1 may be determined based on the uplink slots (or slots which can transmit AP RS or available slots) starting from slot n+O1-A or n+A or n+O1 or slot n. For example, the possible/available values in F1 may be determined based on the uplink slots (or slots which can transmit AP RS or available slots) until the number of values in F1 is H. For example, A is a non-negative integer. In some embodiments, the value of A may be predetermined or configured via at least one of RRC, MAC-CE and DCI. For example, 0≤A≤5 or 0≤A≤10 or 0≤A≤Omax. It should be noted that any other suitable values are also feasible for A.

In some embodiments, if the AP RS is triggered in slot n, the number of F1 and/or the possible values in F1 may be determined based on the uplink slots (or slots which can transmit AP RS or available slots) between slot n+A and slot n+B, where A is a non-negative integer and B is a positive integer. In some embodiments, the value of A and/or B may be predetermined or configured via at least one of RRC, MAC-CE and DCI. For example, 0 ≤A≤5 or 0≤A≤10 or 0≤A≤32. For example,1≤B≤32 or 1≤B≤512. For example, A≤B. It should be noted that any other suitable values are also feasible for A and B.

In some embodiments where multiple resource sets are configured for the first resource, the first information may comprise a first set of slot offset values for the multiple resource sets, and the second information may comprise a set of offset values with respect to the first set of slot offset values. In this case, the terminal device 120 may determine multiple resource sets of the second resource based on the set of offset values and the first set of slot offset values. For example, the number of the multiple resource sets is denoted as N, N is positive integer and 1<N≤16. For example, the number of slot offset values in the first set of slot offset values is denoted as M, M is positive integer and 1<M≤16. For example, the M slot offset values are different to each other. For example, M≤N.

In some embodiments, the set of offset values may be set with respect to at least part of slot offset values in the first set of slot offset values. Here, the part of the slot offset values is denoted as Q slot offset values, 0≤Q≤M. For example, X bits may be set for the field of slot offset update for a single RS resource set, X is positive integer, and 1≤X≤6. In some embodiments, the set of offset values may be set with respect to each of the slot offset values in the first set of slot offset values. For example, X bits may be set for the field of slot offset update for a single RS resource set, X is positive integer, and 1≤X≤6. For example, total X*M or X*Q bits may be needed. In some embodiments, there may be a field to indicate the index of the RS resource set. For example, Y bits or Y = ceil(log2(N)) for the field for RS resource set index, Y is positive integer, and 1≤Y≤4. For example, for each of the P RS resource sets, the total number of bits may be X+Y. For example, total (X+Y)*M or (X+Y)*Q bits may be needed.

Return to FIG. 4, at block 420, the terminal device 120 determines a second resource based on the first and second information. In some embodiments where the terminal device 120 receives third information triggering the communication of the reference signal in a slot, the terminal device 120 may determine the second resource based on the slot and the first and second information. For example, the terminal device 120 may determine a final slot offset value based on the first slot offset value O1 in the first information and the offset value F1 in the second information, and determine, as the second resource, a slot later than the slot of the reception of the third information by the final slot offset value.

In some embodiments, the value of F1 may be an absolute value. That is, the value of F1 is effective in each time of indication. In this case, the final slot offset value may be expressed as O1+F1 or min (max (A, O1+F1), B) or min(O1+F1,B) or max(A, O1+F1). For example, A is a non-negative integer, 0≤A≤Omax or 0≤A≤10. For example, B is a positive integer, A≤B≤512 or 1≤B≤Omax, or 10≤B≤512. In some embodiments, the value of A and/or B may be predetermined. In some embodiments, the value of A and/or B may be configured or preconfigured. For example, A=0. For example, B=32 or 64. It should be noted that any other suitable values are also feasible for A and B.

In some embodiments, the value of F1 may be an accumulated value. In some embodiments, the terminal device 120 may receive, within a predetermined time duration from the reception of the second information, fourth information comprising a further offset value with respect to a sum of the first slot offset value and the offset value. In these embodiments, the terminal device 120 may determine the second resource based on the sum and the further offset value. For example, the final slot offset value may be expressed as

$$\left(\text{O} 1 + {\sum }_{i = 1}^{L} F {1}_{i}\right) ,$$

or min (max (A, B) or B) or max(A,

$$\text{O} 1 + {\sum }_{i = 1}^{L} F {1}_{i}$$

where F1ᵢ denotes an offset value in ith indication about a modification of the first resource, and L denotes the number of the received indications about a modification of the first resource. For example, A is a non-negative integer, 0≤A≤Omax or 0≤A≤10. For example, B is a positive integer, A≤B≤512 or 1≤B≤Omax, or 10≤B≤512. In some embodiments, the value of A and/or B may be predetermined. In some embodiments, the value of A and/or B may be configured or preconfigured. For example, A=0. For example, B=32 or 64. It should be noted that any other suitable values are also feasible for A and B.

At block 430, the terminal device 120 performs the communication of the RS based on the second resource. In some embodiments where the second information comprises an offset value with respect to the first slot offset value, the terminal device 120 may determining whether a first slot is later than a second slot, the first slot being a slot later than a slot of a downlink control channel triggering the communication of the reference signal by a sum of the first slot offset value and the offset value, the second slot being a slot later than a slot of the second resource by a third value. In some embodiments, the third value may be predefined or predetermined based on the capability of the terminal device 120. In some alternative embodiments, the third value may be configured or preconfigured.

If determining that the first slot is later than or no earlier than the second slot, the terminal device 120 may perform the communication of the RS based on the second resource. If determining that the first slot is not later than or earlier than the second slot, the terminal device 120 may perform no offset adjustment. For example, the terminal device 120 may perform the communication of the RS based on the first resource if the first resource is available. For example, the terminal device 120 may not perform or may drop the communication of the RS based on the first resource if the first resource is unavailable.

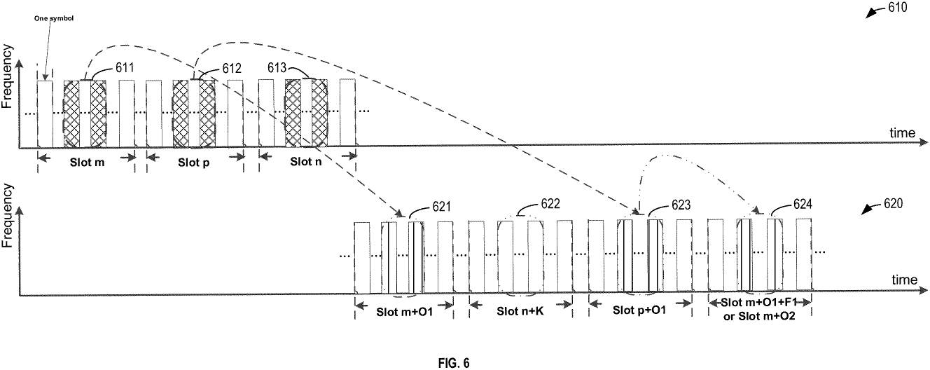

In some embodiments, if AP SRS is triggered in slot m, and if F1 and/or O2 is indicated in slot n, the value of F1 and/or O2 is applied to the AP SRS transmission after a timing T. In some embodiments, the slot n may be no later than slot m. In some embodiments, the slot n may be no earlier than slot m. In some embodiments, T is slot n+K or slot m+K or slot max(n, m)+K or starting of slot n+K or starting of slot m+K or starting of slot max(n, m)+K or ending of slot n+K or ending of slot m+K or ending of slot max(n, m)+K, K is non-negative integer. For example, 0<=K<=480. K denotes the third value as described above. If m+O1+F1 < T or m+O1+F1 <= T or if m+O2 < T or m+O2 <= T, the AP SRS is not adjusted with F1 and/or O2. For illustration, an example will be described in details with reference to FIG. 6.

FIG. 6 illustrates a schematic time-frequency diagram illustrating an effective time of a resource modification according to some embodiments of the present disclosure. Reference sign 610 shows the case of a downlink, and reference sign 620 shows the case of an uplink. Reference sign 611 shows an example of a downlink control channel such as a PDCCH triggering an AP RS in slot m. According to the configured offset in RRC (for example, O1),the AP RS will be communicated in uplink slot m+O1 as denoted by 621. Reference sign 613 shows an example of a PDCCH or MAC CE indicating a modification of the configured offset in slot n. In some embodiments, the slot n may be no later than slot p. In some embodiments, the slot n may be no earlier than slot p. In some embodiments, the timing T is determined as slot n+K or slot p+K or slot max(n, p)+K or starting of slot n+K or starting of slot p+K or starting of slot max(n, p)+K or ending of slot n+K or ending of slot p+K or ending of slot max(n, p)+K. For example, as denoted by 622. According to the modification (for example, O2 or F1), the AP RS will be communicated in uplink slot m+O1+F1 or m+O2 as denoted by 624. As shown in FIG. 6, slot m+O1+F1 or slot m+O2 is later than Slot n+K. In this case, the resource for communication of the RS will be updated or adjusted.

Reference sign 612 shows another example of a downlink control channel such as a PDCCH triggering an AP RS in slot p. According to the configured offset in RRC (for example, O1),the AP RS will be communicated in uplink slot p+O1 as denoted by 623. Reference sign 613 shows an example of a PDCCH or MAC CE indicating a modification of the configured offset in slot n. As shown in FIG. 6, slot p+O1 is later than Slot n+K. In this case, the resource for communication of the RS will be updated or adjusted.

In this way, an effective or application time of the offset adjustment can be determined. In some embodiments, the value of F1 and/or O2 may be applied after one indication, and effective until next indication. In some alterative embodiments, the indicated value of F1 and/or O2 may be applied to the communication of the AP RS (after the indication), and after the communication of the AP RS, then O1 is assumed until new indication of F1 and/or O2.

In some embodiments, according to some embodiments of the present disclosure, the network device may transmit or configure a first information and/or a second information to the terminal device. For example, the first information and/or the second information is transmitted or configured via at least one of RRC, MAC-CE and DCI. Based on the first information and/or the second information, a resource R (for example a slot R) may be determined. The terminal device may determine a resource S (for example a slot S) based on the first information and/or the second information or based on the resource R for communication of a RS. In some embodiments, the resource S or the slot S may be the first available resource or slot starting from the resource R or the slot R.

In some embodiments, according to some embodiments of the present disclosure, the network device may transmit or configure a slot offset O to the terminal device. For example, according to some embodiments of the present disclosure, O may be any one of O1, O2, min(max(A, O1+F1), B), min(O1+F1,B), max(A, O1+F1),

$$\text{O} 1 + {\sum }_{i = 1}^{L} F {1}_{i} ,$$

min (max (A

$$\text{O1+} {Σ}_{i = 1}^{L} F {1}_{i}$$

), B), min(

$$\text{O1+} {Σ}_{i = 1}^{L} F {1}_{i}$$

, B), max(A,

$$\text{O1+} {Σ}_{i = 1}^{L} F {1}_{i}$$

), O1-A, -A, O1+A, O1+F1+A, O2+A and A. In some embodiments, the network device may trigger an RS in slot n. For example, n is non-negative integer. For example, 0≤n≤159. For another example, 0≤n≤2559.

In some embodiments, the terminal device may determine a resource or a slot to transmit the RS. For example, the resource or the slot to transmit the RS is the first (available) uplink resource or first (available) uplink slot for the RS transmission starting from slot n+O or from slot n. In some embodiments, the terminal device may determine a resource or a slot to receive the RS. For example, the resource or the slot to receive the RS is the first (available) downlink resource or first (available) downlink slot for the RS reception starting from slot n+O or from slot n.

In some embodiments, there may be a number G, and G is non-negative integer. For example, 0≤G≤32. For another example, 1 ≤G≤32. For example, the value of G may be predefined or configured. For example, the network device may configure or indicate the value of G via at least one of RRC, MAC-CE and DCI. In some embodiments, the network device may indicate or configure an index g to the terminal device, where g is non-negative integer. For example, 0≤g≤G-1. For another example, 1≤g≤G. In some embodiments, the terminal device may determine a resource or a slot to transmit the RS. For example, the resource or the slot to transmit the RS is the g-th or (g+1)-th (available) uplink resource or g-th or (g+1)-th (available) uplink slot or g-th or (g+1)-th slot for the RS transmission starting from slot n+O or from slot n. In some embodiments, the terminal device may determine a resource or a slot to receive the RS. For example, the resource or the slot to receive the RS is the g-th or (g+1)-th (available) downlink resource or g-th or (g+1)-th (available) downlink slot or g-th or (g+1)-th slot for the RS reception starting from slot n+O or from slot n.

For example, 0≤g≤G-1, and if g=0, the resource or the slot to receive the RS is the first (available) downlink resource or first (available) downlink slot for the RS reception starting from slot n+O or from slot n. For example, 0≤g≤G-1, and if g=1, the resource or the slot to receive the RS is the second (available) downlink resource or second (available) downlink slot for the RS reception starting from slot n+O or from slot n. For example, 1≤g ≤G1, and if g=1, the resource or the slot to receive the RS is the first (available) downlink resource or first (available) downlink slot for the RS reception starting from slot n+O or from slot n. For example, 1≤g≤G, and if g=2, the resource or the slot to receive the RS is the second (available) downlink resource or second (available) downlink slot for the RS reception starting from slot n+O or from slot n.

For example, 0≤g≤G-1, and if g=0, the resource or the slot to transmit the RS is the first (available) uplink resource or first (available) uplink slot for the RS transmission starting from slot n+O or from slot n. For example, 0≤g≤G-1, and if g=1, the resource or the slot to transmit the RS is the second (available) uplink resource or second (available) uplink slot for the RS transmission starting from slot n+O or from slot n. For example, 1≤ g≤G1, and if g=1, the resource or the slot to transmit the RS is the first (available) uplink resource or first (available) uplink slot for the RS transmission starting from slot n+O or from slot n. For example, 1≤g≤G, and if g=2, the resource or the slot to transmit the RS is the second (available) uplink resource or second (available) uplink slot for the RS transmission starting from slot n+O or from slot n.

In some embodiments, according to some embodiments of the present disclosure, the network device may transmit or configure a slot offset V to the terminal device. For example, according to some embodiments of the present disclosure, V may be any one of O1+B, B, O1+F1+B and O2+B. In some embodiments, the network device may trigger an RS in slot n. For example, n is non-negative integer. For example, 0≤n≤159. For another example, 0≤n≤2559.

In some embodiments, there may be a number G, and G is non-negative integer. For example, 0≤G≤32. For another example, 1≤G32. For example, the value of G may be predefined or configured. For example, the network device may configure or indicate the value of G via at least one of RRC, MAC-CE and DCI. In some embodiments, the network device may indicate or configure an index g to the terminal device, where g is non-negative integer. For example, 0≤g≤G-1. For another example, 1≤g≤G. In some embodiments, the terminal device may determine a resource or a slot to transmit the RS. For example, the resource or the slot to transmit the RS is the g-th or (g+1)-th (available) or min(g, J)-th or min(g-1, J)-th uplink resource or g-th or (g+1)-th or min(g, J)-th or min(g-1, J)-th (available) uplink slot or g-th or (g+1)-th or min(g, J)-th or min(g-1, J)-th slot for the RS transmission between slot n+O and slot n+V or between slot n and slot n+V. In some embodiments, the terminal device may determine a resource or a slot to receive the RS. For example, the resource or the slot to receive the RS is the g-th or (g+1)-th or min(g, J)-th or min(g-1, J)-th (available) downlink resource or g-th or (g+1)-th or min(g, J)-th or min(g-1, J)-th (available) downlink slot or g-th or (g+1)-th or min(g, J)-th or min(g-1, J)-th slot for the RS reception starting between slot n+O and slot n+V or between slot n and slot n+V

In some embodiments, there may be J (available) downlink or uplink resources or J (available) downlink or uplink slots or J slots between slot n+O and slot n+V or between slot n and slot n+V, J is non-negative integer. For example, 0≤J≤32. For another example, 1 ≤J≤32. In some embodiments, the value of J may be different from the value of G. For example, J > G. In this case, the first G (available) downlink or uplink resources or the first G (available) downlink or uplink slots or the first G slots may be indicated or configured to the terminal device for the RS communication. For another example, J < G. In this case, the indicated value of g may be 0≤g≤J-1 or 1 ≤g≤J. For example, the value of g larger than J may not be indicated or configured to the terminal device. For another example, if the value of g larger than J is indicated or configured to the terminal device, the RS communication may be dropped. For another example, if the value of g larger than J is indicated or configured to the terminal device, the RS communication may be in the J-th (available) downlink slot or the J-th (available) uplink slot or the J-th slot between slot n+O and slot n+V or between slot n and slot n+V.

In some embodiments, there may be more than one SRS resource sets (For example, U SRS resource sets) configured with a same usage, and U is positive integer. For example, 1 ≤U128. For another example, 1 ≤U≤32. For example, the usage may be at least one of “non-codebook”, “codebook”, “antennaSwitching” and “positioning”. Each SRS resource set can be configured with a slot offset. And one or more of the U SRS resource sets (For example, W SRS resource sets) may be triggered or configured or indicated to the terminal device, W is positive integer. For example, 1 ≤W≤32. For another example, 1 ≤W16. And the terminal device may transmit the W SRS resource sets based on the slot offset configured in the W SRS resource sets.

In some additional embodiments, the terminal device 120 may determine a time interval between the last symbol of a downlink control channel and the first symbol of the second resource, the downlink control channel triggering the communication of the reference signal. If determining that the time interval is above a fourth value, the terminal device 120 may perform the communication of the RS. If determining that the time interval is below the fourth value, the terminal device 120 may drop the RS. In some embodiments, the fourth value may be predetermined. In some embodiments, the fourth value may be configured or preconfigured.

For example, in some embodiments for SRS in a resource set with usage set to “codebook” or “antennaSwitching”, if the time interval between the last symbol of the PDCCH triggering the aperiodic SRS transmission and the first symbol of the SRS resource (for example, the second resource) is less than N2, the AP SRS is dropped. In this case, the fourth value is N2. In some embodiments for SRS in a resource set with usage set to other cases than “codebook” or “antennaSwitching” (for example, with usage “non-codebook” or “beam management” or “positioning”), if the time interval between the last symbol of the PDCCH triggering the aperiodic SRS transmission and the first symbol of the SRS resource (for example, the second resource) is less than N2 +14, the AP SRS is dropped. In this case, the fourth value is N2+14.

For example, in some embodiments for SRS in a resource set with usage set to “codebook” or “antennaSwitching”, the minimal time interval between the last symbol of the PDCCH triggering the aperiodic SRS transmission and the first symbol of the SRS resource (for example, the second resource) is N2. In this case, the fourth value is N2. In some embodiments for SRS in a resource set with usage set to other cases than “codebook” or “antennaSwitching” (for example, with usage “non-codebook” or “beam management” or “positioning”), the minimal time interval between the last symbol of the PDCCH triggering the aperiodic SRS transmission and the first symbol of the SRS resource (for example, the second resource) is N2. In this case, the fourth value is N2 +14. In this case, the fourth value is N2+14.

In some alternative embodiments for SRS in a resource set with usage set to “codebook” or “antennaSwitching”, the terminal device 120 does not expect the time interval between the last symbol of the PDCCH triggering the aperiodic SRS transmission and the first symbol of the SRS resource (for example, the second resource) is less than N2. Otherwise, the terminal device 120 does not expect the time interval between the last symbol of the PDCCH triggering the aperiodic SRS transmission and the first symbol of the SRS resource (for example, the second resource) is less than N2 +14. Here, N2 denotes UE PUSCH preparation procedure time. It should be noted that N2 can be obtained by any existing definition (for example, as specified in TS 38.214) or future developed definition.

In some embodiments, as specified in TS 38.214, N2 is based on the subcarrier spacing value or subcarrier spacing parameter µ for UE processing capability 1 and 2 respectively. For example, for UE capability 1, N2 = 10 symbols if subcarrier spacing value is 15 kHz or µ=0. For another example, for UE capability 1, N2 = 12 symbols if subcarrier spacing value is 30 kHz or µ=1. For another example, for UE capability 1, N2 = 23 symbols if subcarrier spacing value is 60 kHz or µ=2. For another example, for UE capability 1, N2 = 36 symbols if subcarrier spacing value is 120 kHz or µ=4. For example, for UE capability 2, N2 = 5 symbols if subcarrier spacing value is 15 kHz or µ=0. For another example, for UE capability 2, N2 = 5.5 symbols if subcarrier spacing value is 30 kHz or µ=1. For another example, for UE capability 2, N2 = 11 symbols if subcarrier spacing value is 60 kHz or µ=2. For example, the frequency range is frequency range 1 or below 6 GHz.

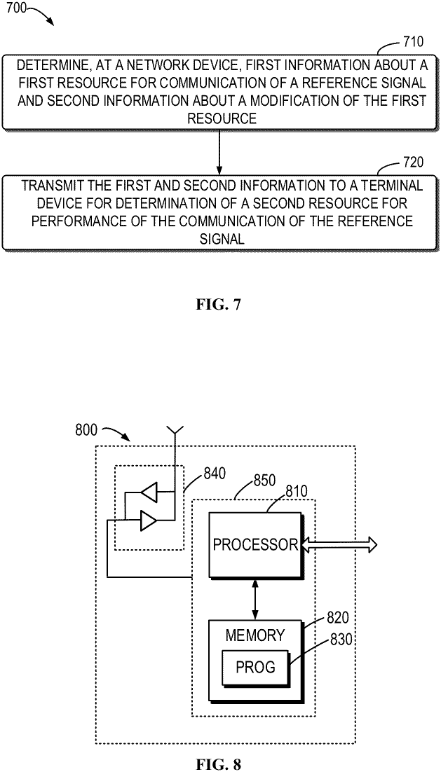

So far, the method implemented at a terminal device is described. Correspondingly, embodiments of the present disclosure also provide a method implemented at a network device. FIG. 7 illustrates an example method 700 of communication implemented at a network device in accordance with some embodiments of the present disclosure. For example, the method 700 may be performed at the network device 110 as shown in FIG. 1. For the purpose of discussion, in the following, the method 700 will be described with reference to FIG. 1. It is to be understood that the method 700 may include additional blocks not shown and/or may omit some blocks as shown, and the scope of the present disclosure is not limited in this regard.

As shown in FIG. 7, at block 710, the network device 110 determines first information about a first resource for communication of a RS and second information about a modification of the first resource. In some embodiments, the network device 110 may cause a first slot offset value of the first resource to be included in the first information, and cause a second slot offset value of the second resource to be included in the second information. In some embodiments, the second slot offset value may be above the first slot offset value.

In some embodiments, the network device 110 may cause a set of first slot offset values to be included in the first information, and cause at least one of a subset in the set; and a slot offset value from the set to be included in the second information.

In some embodiments where multiple resource sets are configured for the first resource, the network device 110 may cause a first set of slot offset values for the multiple resource sets to be included in the first information, and cause a second set of slot offset values to be included in the second information. In some embodiments, the second set of slot offset values may comprise a set of slot offset values for at least part of the multiple resource sets.

In this way, the first resource can be updated, and flexibility of RS resource configuration can be enhanced.

In some alternative embodiments, the network device 110 may cause a first slot offset value to be included in the first information, and cause an offset value with respect to the first slot offset value to be included in the second information. In some embodiments, the offset value may be selected from a set of offset values, and an offset value in the set may be associated with at least one of the first slot offset value and a slot format configuration.

In some embodiments where multiple resource sets are configured for the first resource, the network device 110 may cause a first set of slot offset values for the multiple resource sets to be included in the first information, and cause a set of offset values with respect to the first set of slot offset values to be included in the second information. In some embodiments, the set of offset values may be set for at least part of slot offset values in the first set of slot offset values.

In this way, the first resource can be adjusted, and flexibility of RS resource configuration can be enhanced. In addition, the overhead for the adjustment can be reduced compared with that for the replacement.

At block 720, the network device 110 transmits the first and second information to the terminal device 120 for determination of a second resource for performance of the communication of the RS. In some embodiments, the network device 110 may transmit the first information in a RRC message, and transmit the second information in at least one of a MAC CE and DCI.

In some embodiments, the network device 110 may further transmit, to the terminal device 120, third information triggering the communication of the reference signal. In some embodiments, the network device 110 may further transmit, within a time duration from the transmission of the second information, fourth information comprising a further offset value with respect to a sum of the first slot offset value and the offset value. It should be noted that the first, second, third and fourth information may be transmitted in any other suitable ways.

The implementations of the methods described in FIGS. 4 and 7 substantially correspond to the processes described in connection with FIG. 2, and thus other details are not repeated here. With the methods 400 and 700 according to embodiments of the present disclosure, a dynamic configuration for a RS resource can be achieved, and flexibility of the RS resource configuration can be enhanced. In addition, the related overhead can be saved.

FIG. 8 is a simplified block diagram of a device 800 that is suitable for implementing embodiments of the present disclosure. The device 800 can be considered as a further example implementation of the network device 110 or the terminal device 120 as shown in FIG. 1. Accordingly, the device 800 can be implemented at or as at least a part of the network device 110 or the terminal device 120.

As shown, the device 800 includes a processor 810, a memory 820 coupled to the processor 810, a suitable transmitter (TX) and receiver (RX) 840 coupled to the processor 810, and a communication interface coupled to the TX/RX 840. The memory 810 stores at least a part of a program 830. The TX/RX 840 is for bidirectional communications. The TX/RX 840 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 830 is assumed to include program instructions that, when executed by the associated processor 810, enable the device 800 to operate in accordance with the embodiments of the present disclosure, as discussed herein with reference to FIGS. 1 to 7. The embodiments herein may be implemented by computer software executable by the processor 810 of the device 800, or by hardware, or by a combination of software and hardware. The processor 810 may be configured to implement various embodiments of the present disclosure. Furthermore, a combination of the processor 810 and memory 820 may form processing means 850 adapted to implement various embodiments of the present disclosure.

The memory 820 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 820 is shown in the device 800, there may be several physically distinct memory modules in the device 800. The processor 810 may be of any type suitable to the local technical network, and may include one or more of general purpose computers, special purpose computers, microprocessors, digital signal processors (DSPs) and processors based on multicore processor architecture, as non-limiting examples. The device 800 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3 to 7. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-30. (canceled)

31.
A method comprising:
receiving, from a network device, first information comprising a first slot offset value;
receiving, from the network device, second information comprising a second slot offset value; and
performing communication of a reference signal in a slot x based on the first slot offset value and the second slot offset value.

32.
The method according to claim 31, comprising:
receiving, from the network device, third information triggering the communication of the reference signal in a slot n.

33.
The method according to claim 32, comprising:
performing the communication of the reference signal in the slot x based on the slot n and the first slot offset value and the second slot offset value.

34.
The method according to claim 33, comprising:
the slot x is after the slot n by at least the first slot offset value and the second slot offset value.

35.
The method according to claim 32, wherein
the first information is received, from the network device, in a radio resource control (RRC) message;
the second information is received, from the network device in downlink control information (DCI); and
the third information is received, from the network device in downlink control information (DCI).

36.
The method according to claim 31, wherein
The second slot offset value is above the first slot offset value.

37.
The method according to claim 31, comprising:
determining whether a resource for the reference signal based on the second slot offset value is available; and
performing the communication of the reference signal in the resource in the slot x based on the second slot offset value in accordance with the determination that the resource is available.

38.
The method according to claim 31, wherein
the first information comprises
a set of first slot offset values, and
the second information comprises at least one of the following:
a subset in the set; and
a slot offset value from the set.

39.
The method according to claim 31, wherein
the first information comprises
a first set of slot offset values for multiple resource sets of a resource for the reference signal, and
the second information comprises
a second set of slot offset values, and
determining multiple resource sets of the resource based on the second set of slot offset values.

40.
The method according to claim 31, wherein
the second slot offset value is with respect to the first slot offset value.
